(19) United States
(12) Patent Application Publication
(10) Pub. No.: US 2025/0141665 A1
(43) Pub. Date: May 1, 2025

(54) SIMD RE-RANDOMIZATION FOR LARGE-ENTRY ASYMMETRIC PRIVATE-SET INTERSECTION

(71) Applicant: Duality Technologies, Inc., Maplewood, NJ (US)

(72) Inventors: Andreea ALEXANDRU, Weehawken, NJ (US); Jack BATES, Placitas, NM (US); Marcelo BLATT, Modiin (IL); Nicholas GENISE, Edgewater, NJ (US); Daniele MICCIANCIO, San Diego, CA (US); Yuriy POLYAKOV, Fair Lawn, NJ (US); Vinod VAIKUNTANATHAN, Boston, MA (US)

(73) Assignee: Duality Technologies, Inc., Maplewood, NJ (US)

(21) Appl. No.: 18/925,238

(22) Filed: Oct. 24, 2024

Related U.S. Application Data
(60) Provisional application No. 63/594,070, filed on Oct. 30, 2023.

(51) Int. Cl. H04L 9/08; H04L 9/32

(52) U.S. Cl. CPC H04L 9/0825; H04L 9/0869; H04L 9/3236

(57) ABSTRACT

FHE APSI for intersecting a first party's relatively large dataset X and a second party's relatively small dataset Y with SIMD Re-randomization to prevent data leakage. The first party may use SIMD FHE to execute a simultaneous bin-by-bin comparison of the intersection Y ∩X. The first party may use SIMD FHE to re-randomize each comparison bin by simultaneously executing cyclical rotations on a plurality of slots in each bin to generate randomized comparison bins. The second party, using a secret SIMD FHE key, may simultaneously decrypt the randomized comparison bins to reveal unencrypted randomized comparison bins each either indicating an all-slot full match or a mismatch, but no combination of partial-slot match and mismatch of the bin-to-bin comparison of X and Y to prevent data leakage.

### CROSS-REFERENCE TO RELATED APPLICATIONS

This application claims the benefit of U.S. Provisional Application Ser. No. 63/594,070, filed Oct. 30, 2023, which is hereby incorporated by reference in its entirety.

### FIELD OF THE INVENTION

Embodiments of the invention are directed to data privacy, security, and encryption of secret data. Embodiments of the invention include systems and methods to encrypt secret data to safely share them with an external or third party, for secure external execution of queries, searches, comparisons, intersections, or other computations, only on the encrypted secure data, without decrypting and exposing the underlying unencrypted secret data. In particular, embodiments of the invention are directed to fast and efficient two-party cryptographic protocols, such as, Private-set intersection (PSI), for example, Asymmetric PSI (APSI), for intersecting encrypted data from the two parties.

### BACKGROUND OF THE INVENTION

Private-set intersection (PSI) is a two-party cryptographic protocol where each party's input is a set and the output is the intersection of these sets. Typically only the intersection of the set can be leaked. Asymmetric PSI (APSI) is PSI where the intersected sets are asymmetric such that one set is significantly smaller than the other (e.g., by two or more orders of magnitude). APSI is useful in the client-server setting where a client has a relatively small set and wants to see which of its elements are in the server's relatively large database without leaking its set to the server. Meanwhile, the server wants to provide this service without leaking anything about its database, besides the set intersection.

One existing APSI protocol solves this leakage problem by requiring the entries in the database to be small (e.g., 32 bits). To intersect large entries (e.g., up to 4096 bits), an APSI protocol was developed that uses oblivious pseudo-random function (OPRF) cryptography. OPRF cryptography requires more inter-party communication and unnecessary complexity compared to homomorphic encryption (HE), such as an extra round of communication between the two parties to request and send OPRF parameters providing an extra layer of obfuscation to ensure the querying party remains oblivious and prevent data leakage. Further, standard OPRFs rely on elliptic curve cryptography, which are typically not secure against quantum attacks (e.g., quantum computers can typically break encryption in polynomial time).

Accordingly, there is a need in the art for a more secure and efficient PSI and APSI protocol that solves these problems.

### SUMMARY OF THE INVENTION

To overcome the aforementioned problems inherent in the art, embodiments of the invention may provide a large entry APSI protocol with improved efficiency and security compared to the conventional OPRF based APSI protocol. Embodiments of the invention provide an APSI protocol supporting large entries that uses Fully Homomorphic Encryption (FHE) to divide those large entries into distinct bins and operate simultaneously thereon using Single Instruction/Multiple Data (SIMD) operations. The encryption of FHE improves security for resilience against quantum attacks. Encryption using FHE also reduces inter-party communication compared to OPRF thereby significantly increasing speed and efficiency. Instead of relying on oblivious transfer, the APSI protocol according to embodiments of the invention prevents data leakage between the two parties by re-randomizing the intersection data under FHE (e.g., only indicating a full intersection where both parties already have the same data, but not a partial intersection revealing partial data entry information about the other party's data).

In accordance with an embodiment of the invention, a device, system and method is provided for executing an APSI protocol to intersect a relatively small dataset Y provided by a second (e.g., “receiver”) party R with a relatively large dataset X provided by a first (e.g., “sender”) party S. The first party S may store the relatively large dataset X and sort it into a plurality of bins, each bin representing a distinct data entry, and each bin comprising a plurality of slots. The second party R may generate and send to the first party S, a SIMD FHE ciphertext encrypting the relatively small dataset Y using a public SIMD FHE key, and sort the ciphertext into a plurality of bins ctₖ, each bin representing a ciphertext of a distinct data entry, and each bin comprising a plurality of slots. The first party S may execute, using SIMD FHE, a simultaneous bin-by-bin comparison of the bins of X with the bins of ciphertexts ctk of Y to generate a plurality of comparison bins ct′ₖ each comparing data entry pairs of X and Y. The first party S may re-randomize or normalize, using SIMD FHE, the bin-by-bin comparison by simultaneously executing a cyclical rotation, randomization and aggregation on a plurality of slots in each of the plurality of comparison bins ct′ₖ to generate a plurality of randomized comparison bins ct″ₖ. The first party S may send the second party R the plurality of randomized comparison bins ct″ₖ. The second party R may simultaneously decrypt the plurality of randomized comparison bins ct″ₖ using a secret SIMD FHE key paired with the public SIMD FHE key to reveal a plurality of unencrypted randomized comparison bins. Each unencrypted randomized comparison bin may either indicate a full match (e.g., containing all slots with a match value, such as, zero) or indicate a mismatch (e.g., containing all slots with a mismatch match value, such as, randomized non-zero values) of the bin-to-bin comparison of the relatively large dataset X and the encrypted relatively small dataset Y. None of the plurality of unencrypted randomized comparison bins may contain a combination of slots indicating a partial match (e.g., containing slots with a combination of both a match (zero) and mismatch (non-zero) values) of the bin-to-bin comparison, thereby preventing data leakage between the first and second parties S and R. FHE provides post-quantum security reduced inter-party communication, while re-randomization prevents data leakage to improves APSI security and efficiency, compared with the conventional OPRF based APSI protocol. Additional improvements include runtime-optimized APSI protocols (e.g., Algorithm 2) and memory-optimized APSI protocols (e.g., Algorithm 3).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a multi-party system for executing an APSI protocol using SIMD re-randomization, according to an embodiment of the invention; and

FIG. 2 is a flowchart of a method for a multi-party APSI protocol using SIMD re-randomization, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Embodiments of the invention provide an APSI protocol to detect intersections of datasets X and Y of respective parties S and R using Fully Homomorphic Encryption (FHE) and Single Instruction/Multiple Data (SIMD) operations. Compared to conventional OPRF protocols that require extra OPRF initialization communications to perform oblivious transfer, the APSI protocol according to embodiments of the invention eliminates those initialization communications to reduce inter-party communication and improve APSI speed due to reduced transmission times. Instead, the APSI protocol according to embodiments of the invention executes a re-randomization process to prevent data leakage. FHE further improves APSI security because, unlike the conventional elliptic curve based APSI protocol, FHE is secure against quantum attacks (e.g., quantum computers can not typically break FHE in polynomial time). FHE can also be parallelized to optimize efficiency by dividing each distinct data entry of X and Y into a unique bin to apply SIMD operations thereon to execute APSI operations simultaneously and independently over the multiple data bins/entries. Each single data bin/entry may be further subdivided into multiple slots which allows the APSI protocol according to embodiments of the invention to intersect large data entries of datasets X and Y by parallelizing computations across multiple slots of each entry (e.g., supporting large data entries up to an order of 10² or 10³ bits). Additionally, a runtime-optimized APSI protocol further reduces the number of computations and runtime for APSI (e.g., using a number of cyclic rotations that is linear with a number of slots in the data bins, as shown in Algorithm 2) and a memory-optimized APSI protocol further reduces memory usage for storing rotation keys as well as reduces communication for transmitting those keys (e.g., using only two rotation keys, as shown in Algorithm 3) compared to each other.

Embodiments of the invention execute a “re-randomization” or “normalization” of the intersection data to prevent data leakage between the two parties in the APSI protocol so neither party can access each other's data. Re-randomization shuffles, mixes and randomizes slot-to-slot comparisons (results of digit-to-digit intersections) across multiple slots of each bin to produce bin-to-bin (not slot-to-slot) comparisons (results of full entry-to-entry, not digit-to-digit, intersections), thereby only revealing full match intersections where both parties already possess the intersection data, but not allowing partial match intersections that reveal information a party does not already possess.

A first party (e.g., a “data owner” or “sender” S) with a relatively large dataset X (e.g., a secret or public, encrypted or unencrypted, database, document(s), file(s), etc.) may perform the APSI protocol collaboratively with a distinct external second party (e.g., a “querier” or “receiver” R) with a relatively small dataset Y (e.g., a query or search data entry). The second party R may transmit its data Y protected as one or more ciphertext(s) under FHE to the external first party S. The size (e.g., number of data entries, memory usage to store entries, etc.) of the relatively small dataset |Y| (e.g., 1-10) may be two or more orders of magnitude smaller than the size of the relatively large dataset |X| (e.g., >>10³, such as, an order of 10⁶, 10⁹ or larger). Due to the bin division of data entries, embodiments of the invention may support intersecting “large” data entries in X and Y (e.g., up to an order of 10³ bits) and significantly larger (e.g., an order or two or magnitude greater than) compared to the conventional small entry APSI protocol (supporting up to 32 bits). The first party S may perform the APSI protocol locally intersecting the encrypted relatively small dataset Y with its (e.g., unencrypted or encrypted) relatively large dataset X, without exposing the unencrypted dataset Y (except its intersection with its known dataset X). The intersection data is re-randomized such that the first party S can only detect if there is a full match of a complete data entry across all slots of an entire bin, but not if there is a partial match of a part of a data entry across some (but not all) slots of the bin.

An example APSI protocol according to an embodiment of the invention (e.g., Protocol PQ-APSI below) may input the relatively large dataset X of the first party S and the relatively small dataset Y of the second party and output the intersection of the two datasets Y ∩X. In various embodiments, the first and second parties S and R may hash their respective datasets X and Y (e.g., PQ-APSI Algorithm, Steps 1 and/or 3), or may not (skipping PQ-APSI Algorithm, Steps 1 and/or 3). The first party S may sort the relatively large (hashed or unhashed) dataset X into a plurality of l bins, each bin comprising a plurality of slots (e.g., PQ-APSI Algorithm, Step 2). The second party R may generate a SIMD FHE ciphertext encrypting the (hashed or unhashed) relatively small dataset Y using a public SIMD FHE key, and send the ciphertext to the first party S, sorted into a plurality of bins ctₖ, each bin comprising a plurality of slots (e.g., PQ-APSI Algorithm, Step 4). The first party S may execute a SIMD FHE intersection computation to simultaneously bin-by-bin and slot-by-slot compare each individual slot in each bin of X separately with each individual slot in each bin of ciphertexts ctₖ of Y to generate a plurality of comparison bins ct′ₖ (e.g., PQ-APSI Algorithm, Step 5). The first party S may execute a SIMD FHE re-randomization or normalization of the bin-by-bin comparison to obfuscate individual slot-to-slot results by simultaneously executing a cyclical rotation, randomization and aggregation on a plurality of slots in each of the plurality of comparison bins ct′ₖ to generate a plurality of randomized comparison bins ct″ₖ (e.g., PQ-APSI Algorithm, Step 5). The cyclical rotation shifts the slots and the aggregation mixes the results of multiple different slots within each bin (but not between different bins, so there is no bin-to-bin data cross-over). Thus, where each comparison bin ct″ₖ represents an intersection of an entire data entry of Y with an entire data entry of X, and its multiple slots represent an intersection of the multiple respective digits of those data entries, re-randomization or normalization mixes those slots to each represent an aggregate or cumulative intersection of multiple different digits of the same data entry so no individual single slot or digit information is leaked in a partial intersection. The first party S may flood the plurality of randomized comparison bins ct″ₖ with noise and send the results to the second party R (e.g., PQ-APSI Algorithm, Step 6). The second party R may simultaneously decrypt the plurality of randomized comparison bins ct″ₖ using a secret SIMD FHE key paired with the public SIMD FHE key to reveal a plurality of unencrypted randomized comparison bins (e.g., PQ-APSI Algorithm, Step 7). The second party R may evaluate the plurality of unencrypted randomized comparison bins that each contain all zero slots to indicate a perfect or maximum intersection Y ∩X=X=Y, i.e., a full match of all digits in all slots of the data entries of X and Y or that each contain all randomized non-zero slots to indicate a mismatch of any single (or more) digit in a single (or more) slot of the data entries of X and Y. Because of the re-randomization or normalization (e.g., PQ-APSI Algorithm, Step 5) mixes the comparisons across slots within the same bin, the comparison bins show an all-slot match or not, and none of the plurality of unencrypted randomized comparison bins may contain a combination of match (zero) slots and no match (non-zero) slots indicating a partial match of the bin-to-bin comparison. The re-randomization or normalization thus makes it impossible to know which or how many slots (digits) do not match, or to differentiate between any number of slot mismatches, e.g., from an almost exact partial match (matching all except one l−1 digits (slots)) to a complete no-digit match (matching no digits (slots)), thus preventing data leakage.

Embodiments of the invention may extend APSI from a two-party protocol to any integer number of M parties, where the M parties may sequentially execute the APSI protocol sequentially pairwise by each sequential pair of parties (i and i+1) operating as the first and second parties S and R, where the pair of parties is iteratively incremented by one (from i+1 to i+2) for each sequential iteration. For example, a sequence of M parties may perform the APSI protocol pairwise as parties 1 and 2, then 2 and 3, then 3 and 4, and so on, until a final pair of parties M−1 and M.

Embodiments of the invention support any encryption scheme that is modular such as FHE and supports SIMD operations, including but not limited to, for example, Brakerski-Gentry-Vaikuntanathan (BGV), Brakerski/Fan-Vercauteren (BFV), and Cheon-Kim-Kim-Song (CKKS) encryption schemes.

BGV and BFV are two SIMD (single instruction, multiple data) homomorphic encryption schemes with identical plaintext spaces. Their ciphertexts are SIMD, such that, each ciphertext encrypts a vector of N plaintext integers modulo a prime p such that p=1 mod 2N. Their ciphertexts can allow for SIMD additions and SIMD multiplications. A BGV/BFV ciphertext is ciphertext (c₀, c₁) ∈R_{Q}², where each c₀ and c₁ are integer polynomials of dimension N (degree at most N−1), N is a power of two, representing a polynomial in R_{Q}=Z_{Q}[X]/(X^{N}+1) where Z_{Q} is the set of integers modulo Q. Further, the integers modulo Q can be represented with balanced residues, i.e.

$${Z}_{Q} = \{ - \frac{Q - 1}{2} , … , - 1 , 0 , 1 , … , \frac{Q - 1}{2} \}$$

### if Q is odd.

APSI protocols from BGV and BFV can represent the smaller dataset Y with one or a few BGV/BFV ciphertexts. Dataset entries can be represented by length-l contiguous blocks, called “bins”, and each ciphertext can encrypt N/l dataset entries. APSI protocols can begin with the second party R (e.g., a client) encrypting the smaller dataset Y in BFV or BGV and sending the first party S (e.g., a server) these ciphertexts and homomorphic rotation keys. The first party S can then homomorphically evaluate polynomials on these vectors such that a match in an entry results in a 0 and a mismatch results in a random element modulo p in this entry. In conventional APSI there can be an issue with partial matching since, for example, if one party's entry is (a,b) and the other party's entry is (b,b), then the intersection is (random, 0) which leaks partial information about the entry (b,b). This can be unacceptable since this can leak information about elements outside of the intersection. The re-randomization algorithm may be run by the first party S after polynomial intersection evaluation to prevent this leakage.

An embodiment of the invention provides post-quantum APSI (“PQ-APSI”) for large entries. APSI may be parameterized by Cuckoo hashes {hᵢ}, a cryptographic hash function H, and an arithmetic FHE scheme with SIMD multiplication (e.g., BFV, BGV, or CKKS). An example PQ-APSI protocol follows using BGV encryption:

Protocol PQ-APSI for Large Entries

Input: A receiver set Y and a sender set X, |Y| << |X|. Both parties have
the Cuckoo hashes (hashᵢ}
Output: The receiver gets Y ∩ X and the sender gets nothing.

| | |
|---|---|
| 1: | S hashes its set, X, by X′ = {x′\|x′ = H(x), x ϵ X}. |
| 2: | S populates its bins with each Cuckoo hash, pads them to be all the |
| | same size, then computes the bin polynomials binᵢⱼ(z) = II_{x′ϵbin}_{ᵢ} |
| | (z − x′[j]), j ϵ [l]. |
| 3: | R hashes its elements: Y′ = {y′\|y′ = H(y), y ϵ Y}. |
| 4: | R then computes its bin with Cuckoo hashing, then it encrypts its |
| | bins in BGV SIMD ciphertexts {ctₖ} and sends them to S. |
| 5: | S computes the bin polynomials homomorphically: {ct′ₖ}. If a bin is |
| | split across more than one alot, it normalizes them with Algorithm |
| | normalize: {ctₖ″} ← {normalize(ct′ₖ)}. |
| 6: | S noise floods the result. {ctₖ′′′} ← {ctₖ″ + (0, _{X}_{_{flood}})}. It sends the |
| | encrypted ciphertexts back to R. (1 round) |
| 7: | R decrypts and evaluates. |

In Step 1 of PQ-APSI, the first party S may encode its dataset, X, by X′={x′|x′=H(x), x ∈X}. It can do this before or after interacting with the second party R.

In Step 2 of PQ-APSI, the first party S may then apply all Cuckoo hashes to its encoded values to populate bins. That is, the first party S can place x′ in bin j if hᵢ(x′)=j for any of the indices i. (This may not be considered Cuckoo hashing since there are generally going to be many collisions.)

In Step 3 of PQ-APSI, the second party R may hash its set to compute Y′={y′|y′=H(y), y ∈Y} where Y is the second party R's input. It can be assumed that |Y|<<|X|.

In Step 4 of PQ-APSI, the second party R may then sort its dataset Y into bins: it places y′ in bin j if Cuckoo(y′)=j. Therefore, the second party R may have no collisions in its bins with high probability. For example, the second party R's bins might be bin₁=empty, bin₂={y′₉}, . . . whereas the first party S's bins could be bin₁={x′₄₀₀, x′₇₈₀, . . . , x′₁₀₀₀₁}, . . .

In Step 2 of PQ-APSI, the first party S may form an intersection polynomial for each bin, binᵢ, that evaluates to zero (e.g., when a slot-to-slot comparison matches X and Y) or one (e.g., when a slot-to-slot comparison does not match X and Y) for every element/slot in the bin. This polynomial may be denoted as binᵢⱼ(z) in the protocol where j ∈{0, 1, . . . , l}.

In Step 4 of PQ-APSI, the second party R may encode its set into ciphertexts, {ctₖ}, and sends them to the first party S as well as an evaluation key for rotations.

In Step 5 of PQ-APSI, the first party S may compute its bin polynomials on the second party R's ciphertexts, e.g., with plaintext-ciphertext operations, and the first party S may run normalize (ctₖ) to re-randomize each bin polynomial ciphertext.

In Step 6 of PQ-APSI, the first party S may flood the resulting ciphertexts to hide its bin polynomials and returns the result to the second party R.

In Step 7 of PQ-APSI, the second party R may decrypt and evaluate or publish the result.

In some embodiments, instead of BGV, the above example PQ-APSI protocol may be modified to use the BFV, CKKS or another modular SIMD encryption scheme.

### Re-Randomization

Re-randomization or normalization (e.g., “normalize (ct′ₖ)” in PQ-APSI Algorithm, Step 5) may randomize the slots to prevent data leakage, e.g., as follows: If a bin is split across l slots, a different random sum of the slots may be added in each slot. For example, if a bin contains two slots, the bin (a, b) gets transformed to (α₀a+α₁b, β₀a+β₁b), where αᵢ, βᵢ← [symbol] ₚ (integers modulo p). Therefore, all the slots in a re-randomized bin will be uniformly random non-zero values as long as one element or digit in the comparison bin is non-zero (not matching in Y and X). The chance of a false positive (obtaining a match (zero) when the correct intersection gives a mismatch (non-zero)) is e.g. p⁻² for a two-slot bin and p^{-l} for any integer l-slot bin.

Re-randomization or normalization may be optimized for reduced runtime (e.g., as shown in Algorithm 2) or optimized for reduced memory/communication usage by using relatively fewer rotation keys (e.g., as shown in Algorithm 3).

Re-randomization may be optimized to reduce runtime by using a number of cyclic rotations and a number of rotation keys that is linear with the number of slots l in each of the plurality of comparison bins ct′ₖ. Re-randomization may be parallelized for multiple or all bins using SIMD FHE to simultaneously cyclically rotate the l slots in each bin (minus one) in each of two directions, e.g., using 2 (l−1) cyclic rotations and 2 (l−1) rotation keys.

According to an embodiment of the invention, each of the comparison bins ct′ₖ may be simultaneously re-randomized (e.g., normalize (ct′ₖ) in PQ-APSI Algorithm, Step 5). Re-randomization may divide the ciphertext of each comparison bin ct′ₖ into a ciphertext of the first segment of slots ct; (e.g., comprising the first l−i entries of ct′ₖ) and a ciphertext of the second remaining segment of slots ct′ᵢ (e.g., ct′ₖ−ctᵢ comprising the remaining i entries not in the first slot segment ctᵢ) (e.g., Algorithm 2, Steps 5 and 6). The ciphertext of each comparison bin ct′ₖ may be simultaneously shifted, randomized and accumulated (e.g., Algorithm 1, Step 7). The ciphertext of each comparison bin ct′ₖ may be shifted by simultaneously cyclically rotating the first slot segment ctᵢ by shifting its slot indexes in a first (e.g., forward, rightward) direction within the bin by a first set of i rotation keys and, in parallel, cyclically rotating the second slot segment by shifting slot its indexes in a second (e.g., reverse, backward, or leftward) direction within the bin by a second set of i−l rotation keys (e.g., Algorithm 1, Step 7).

An example run-time optimized re-randomization Algorithm 2 is:

Algorithm 2 Runtime-Optimized Slot Normalization, normalizeₚₐᵣₐₗₗₑₗ(ct)

Input: A SIMD ciphertext ct encrypting N/l l-sized bins with plaintext
prime p.
Rotation keys for rotations by 1, 2, . . . , l − 1 and for −l + 1, −l + 2, . . . ,
−1; 2(l − 1) in total.
Output: A ciphertext ct with 0 in the 0-bins and a random vector
otherwise.

| 1: | (Can be offline) Compute pᵢ(X) = encode((dᵢ)^{N/l}), where dᵢ ϵ [symbol] ₚ^{l} is | |
|---|---|---|
| | a vector with i contiguous 0's from right to left for i = 1, . . . , l − 1: | |
| | d₁ = (1, 1, 1, 1, . . . , 1, 0), d₂ = (1, 1, 1, . . . , 1, 0, 0), . . . , and | |
| | dₗ₋₁ = (1, 0, . . . , 0). | |
| 2: | (Can be offline) Sample l random polynomials: rᵢ(X) = encode(rᵢ) for | |
| | rᵢ ← [symbol] ₚ^{N} and i ϵ {0, 1, . . . , l − 1}. | |
| 3: | Randomize the original ciphertext: ct₀ ← ct · r₀(X). | |
| 4: | for i ϵ {1, . . . , l − 1] do | |
| 5: | Form a ciphertext with the first l − i entries of ct: ctᵢ ← ct · pᵢ(X) | |
| 6: | Form a ciphertext with the rest of the entries: ctᵢ′ ← ct − ctᵢ | |
| 7: | Shift, randomize, and accumulate\|: | |
| | | ctᵢ ← (rotate(ctᵢ, i) + rotate(ctᵢ′, −l + i) · rᵢ(X) |

| | |
|---|---|
| 8: | end for |
| 9: | return ct_{acc} ← Σᵢ ctᵢ. |

Slot normalization algorithm. The function rotate(ct, i) shifts a ciphertext's slots by i to the right if i≥0 and to the left if i<0. Note, the first rotation, rotate(ct, i), can be executed with fast, hoisted rotations by re-arranging the mask and rotate operations.

Algorithm 2, e.g., executed at the first party S, may input a ciphertext of the plurality of comparison bins ct′ₖ (e.g., bin-by-bin intersection of X and encryption of Y), as well as 2(l−1) rotation keys. The output of Algorithm 2 may be a re-randomized ciphertext (normalize (ct′ₖ)) with either all zeros, e.g., (0, 0, . . . , 0) ∈ [symbol] ^{l}ₚ (an l-length zero vector) or all uniformly random non-zero values (an l-length vector of integers modulo p in [symbol] ^{l}ₚ) in each of its bins, but cannot be a mixture of zeros and non-zeros.

In Step 1 of Algorithm 2, the first party S may form l−1 selector polynomials pᵢ(X) to select l−1 different segments of slots in a bin (e.g., 1's indicating the selected segment indexes and 0's indicating the deselected segment indexes).

In Step 2 of Algorithm 2, the first party S may sample l uniformly random plaintext polynomials rᵢ(X).

Steps 3-9 of Algorithm 2 executes masking, rotating, and randomizing the input ciphertext.

In Step 3 of Algorithm 2, the first party S may randomize the initial ciphertext.

In Steps 4-8 of Algorithm 2, for each ith slot index in the l-length bin, the first party S may form a parallelizable loop simultaneously executed over all bins, which randomizes the correctly masked and shifted ciphertext. Note, the first rotation forming ctᵢ can be done with fast, hoisted rotations by rearranging the mask and rotate operations (Step 7). Alternatively, the multiplications by masking polynomials and rotations can be represented as a linear transformation, with the diagonalization used for evaluating the plaintext-matrix-ciphertex-vector multiplication (e.g., also using fast, hoisted rotations).

In Step 9 of Algorithm 2, the first party S may return the sum of all slot segments ctᵢ (over all rotated slots).

Compared to Algorithm 2 reducing the number of computations, Algorithm 3 minimizes the number of rotation keys to two. of Algorithm 3 divides the ciphertext into a plurality of l single-slot ciphertexts (e.g., Algorithm 3, Steps 1-3). For example, a two slot bins, l=2, is divided into two ciphertexts: bins (a, b) get split into (a, 0) in one ciphertext and (0, b) in the other. In general, an l-slot ciphertext gets split into l single-slot ciphertexts. The rest of the algorithm is dedicated to masking, randomizing, and rotating each single-slot ciphertext by a single shift using one of the two rotation keys (e.g., rotating in one of the two directions) a repeated number of times until the single-slot ciphertext is fully rotated equivalent to the multi-slot rotations of Algorithm 2. This optimization of Algorithm 3, while reducing the number of rotation keys to two (and thereby reduce their communication from party R to party S and storage at party S), comes at the cost of increasing runtime to execute a greater number of rotations because each rotation only moves a slot one index at a time.

An example memory/communication optimized re-randomization Algorithm 3 is:

Algorithm 3 Memory-Optimized Slot Normalization, normalizeₛᵢₘₚₗₑ(ct)

Input: A SIMD ciphertext ct encrypting N/l l-sized bins with plaintext
prime p.
Rotation keys for rotations by −1, 1.
Output: A ciphertext ct with 0 in the 0-bins and a random vector
otherwise.

| | |
|---|---|
| 1: | (Can be offline) Compute pᵢ(X) = encode((eᵢ)^{N/l}), where eᵢ ϵ [symbol] ₚ^{l} is |
| | the i-th indicator vector, for i = 0, . . . ,l − 1. |
| 2: | (Can be offline) Sample l² random polynomials: r_{i,j}(X) = encode(r_{i,j}) |
| | for r_{i,j} ← [symbol] ₚ^{N} and i,j ϵ (0, 1. . . ,l − 1}, |
| 3: | Split the ciphertext into l ciphertexts by masking: ctⱼ ← ct · pⱼ(X). |
| | Initialize an accumulator ciphertext ct′ = (0, 0) ϵ R_{q}². Initialize |
| | \tilde{c}tⱼ ← ctⱼ. The ciphertexts ctⱼ are fixed throughout and \tilde{c}tⱼ are updated |
| | with rotations. |
| 4: | for j = 0, 1, . . . ,l − 1 do |
| 5: | ct′ ← ct′ + (\tilde{c}tⱼ · r_{0,j}(X)) |
| 6: | end for |
| 7: | for i = 1, . . ,l − 1 do |
| 8: | for j = 0, 1, . . . ,l − 1 do |
| 9: | if i + j == l then |
| 10: | \tilde{c}tⱼ ← rotate(ctⱼ, − 1). |
| 11: | else if i + j > l then |
| 12: | \tilde{c}tⱼ + rotate(\tilde{c}tⱼ, − 1). |
| | else |
| 14: | \tilde{c}tⱼ ← rotate(\tilde{c}tⱼ, 1) |
| 15: | end if |
| 16: | ctⱼ* ←\tilde{c}tⱼ · r_{i,j}(X). |
| 17: | ct′ ← ct′ + ctⱼ*. |
| 18: | end for |
| 19: | end for |
| 20: | return ct′. |

Slot normalization algorithm. The function rotate (ct, i) shifts a ciphertext's slots by i to the right if i≥0 and to the left if i<0. Note, this function is parameterized by the APSI parameters: N, q, p, l.

In Step 1 of Algorithm 3, the second party S may generate vector ei to select a single slot at each index i (and mask or zero the remainder of the slots in the ciphertext).

In Step 2 of Algorithm 3, the second party S may sample l² random polynomials (vs l in Algorithm 2).

In Step 3 of Algorithm 3, the second party S may extract and isolate each single slot as an independent ciphertext.

Steps 4-6 of Algorithm 3 may set the accumulator ciphertext ct′ to a randomized sum of all slots in ct. In other words, each slot is extracted and multiplied by a random number, and a sum of all these products is computed and stored in the accumulator ciphertext ct′.

In Steps 7-15 of Algorithm 3, the second party S may use two rotation keys to individually shift each single slot by one slot index at a time in each of two respective directions, repeatedly a number of times to shift the single slot multiple total slot indices in each direction. The second party S may rotate the slots a quadratic number of l² times because each slot is rotated one slot at a time, thus allowing only two key for the two rotation directions. For example, the second party S may shift a slot g indices by g single-slot-shift rotation operations using a single rotation key.

In Step 16 of Algorithm 3, the first party S may randomize the rotated (mixed) results.

In Step 17 of Algorithm 3, the first party S may return the sum (aggregate) of all slot segments (over all rotated slots).

Additional or different steps, orders of steps or computations may be used than shown in Algorithm PQ-APSI, Algorithm 2 and/or Algorithm 3.

Additionally or alternatively, a partial runtime and partial memory optimization balancing the benefits of reducing rotation keys and reducing rotation operations may be used, in which more keys may be used than the two in Algorithm 3 (e.g., 4, such as a single and double slot shift in each direction), but fewer keys may be used than 2(l−1) in Algorithm 2, yielding fewer rotations than in Algorithm 3, but more than in Algorithm 2.

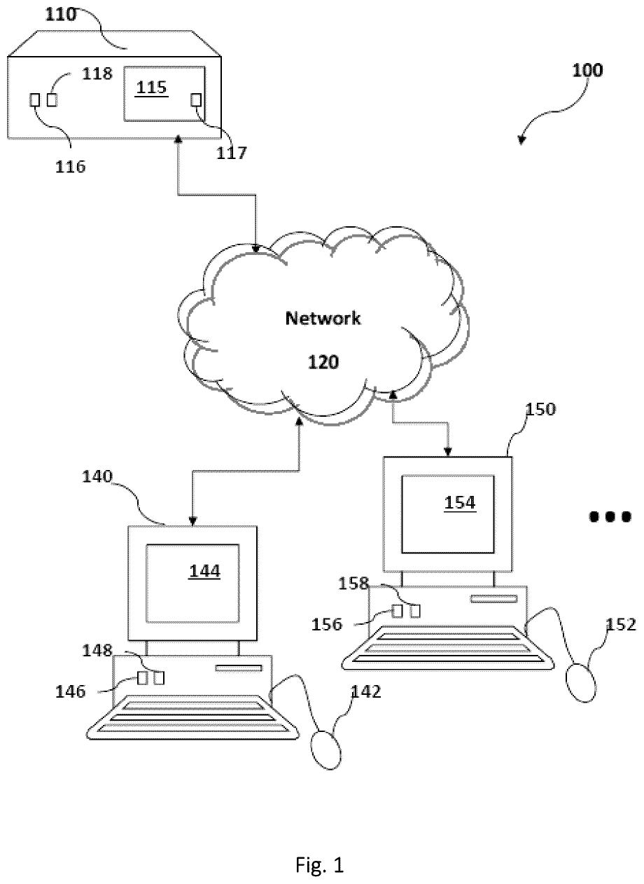

Reference is made to FIG. 1, which schematically illustrates a multi-party system 100 for SIMD re-randomization in an APSI protocol, according to an embodiment of the invention. The above described embodiments may be executed using any single or combination of devices and/or components of system 100 of FIG. 1.

System 100 may execute the APSI protocol using two parties, such as, a first party S operating one or more server(s) 110 (e.g., a data owner of one or more database(s) 115) and a second party R operating a client device 140 (e.g., a client querying database(s) 115). System 100 may be expanded to any integer number of M first and or second parties (e.g., using multiple client device(s) 140, 150, . . . ) executing the APSI protocol pairwise in a sequential chain of pairs of parties (e.g., parties 1 and 2, 2 and 3, . . . , M−1 and M).

Each party's device(s) 110, 115, 140, and 150, may include one or more server(s), storage device(s), computer(s) such as, personal computers, desktop computers, mobile computers or devices, laptop computers, and notebook computers or any other suitable device such as a cellular telephone, personal digital assistant (PDA), video game console, etc., and may include wired or wireless connections or modems. Client device(s) 140 and 150 may include respective memories 148 and 158 for storing client information. Client device(s) 140 and 150 may include one or more input devices 142 and 152, respectively, for receiving input from a user. Client device(s) 140 and 150 may include one or more output devices 144 and 154 (e.g., a monitor or screen) for displaying data to the data owner provided by or for server(s) 110.

Database(s) 115 may be a storage device comprising one or more memor (ies) 113 to store encrypted data 117 (e.g., ciphertexts ctk of the relatively small dataset Y) provided by client device(s) 140 and 150 (e.g., second party R). In alternate embodiments, database(s) 115 may be omitted and client encrypted information 117 may be stored in an alternate location, e.g., exclusively in memory unit(s) 148 and 158 of the respective entity devices, or in host device memory 118.

Any or all of system 100 devices may be connected via one or more network(s) 120. Network 120 may be any public or private network such as the Internet. Access to network 120 may be through wire line, terrestrial wireless, satellite or other systems well known in the art.

Each system device 110, 115, 140, and 150 may include one or more controller(s) or processor(s) 116, 111, 146, and 156, respectively, for executing operations according to embodiments of the invention and one or more memory unit(s) 118, 113, 148, and 158, respectively, for storing data (e.g., client information, private decryption keys, public encryption keys, rotation keys, etc.) and/or instructions (e.g., software for applying computations or calculations to encrypt, decrypt, mask, randomize, rotate, accumulate data, and other operations according to embodiments of the invention) executable by the processor(s). Memory unit(s) 118, 113, 148, and 158 may include a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller (e.g., one or more of processor(s) 116, 111, 146, and/or 156), carry out methods disclosed herein. Processor(s) 116, 111, 146, and/or 156 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 118, 113, 148, and/or 158 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

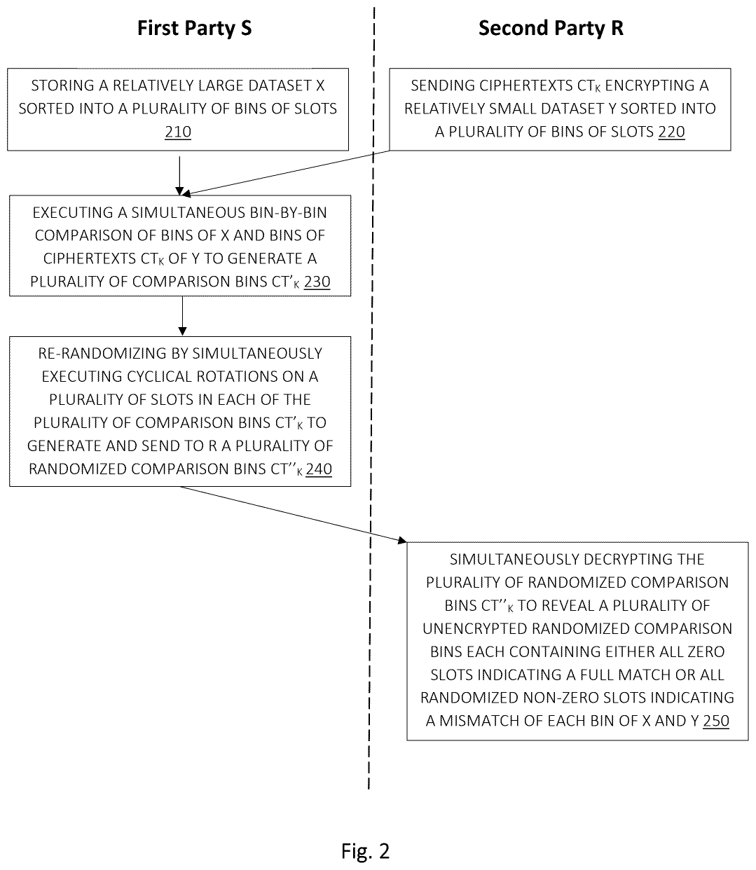

Reference is made to FIG. 2, which is a flowchart of a method for SIMD re-randomization in an APSI protocol, according to an embodiment of the invention. The operations of FIG. 2 may be executed using any single or combination of devices and/or components of system 100 of FIG. 1. For example, first party S operations may be executed by one or more server(s) 110 and second party R operations may be executed by one or more client device(s) 140 and 150 (or vice versa).

In operation 210, one or more processor(s) at a first party S may store a relatively large dataset X sorted into a plurality of bins, each bin representing a distinct data entry, each bin comprising a plurality of slots, and each slot representing a distinct digit of its bin's data entry. The first party S may or may not hash the relatively large dataset X.

In operation 220, one or more processor(s) at a second party R, using a (public or private) SIMD FHE key, may generate and send to the first party S, a SIMD FHE ciphertext encrypting a relatively small dataset Y sorted into a plurality of bins ctₖ. Each bin ctₖ may represent a distinct data entry, each bin may comprise a plurality of slots, and each slot may represent a distinct digit of its bin's data entry. The second party R may or may not hash the relatively small dataset Y.

In operation 230, one or more processor(s) at the first party S, using SIMD FHE, may execute a simultaneous bin-by-bin comparison of the bins of X with the bins of ciphertexts ctₖ of Y to generate a plurality of comparison bins ct′ₖ.

In operation 240, one or more processor(s) at the first party S, using SIMD FHE, may re-randomize by simultaneously executing cyclical rotations, randomizations and/or an aggregation on a plurality of slots in each of the plurality of comparison bins ct′ₖ to generate a plurality of randomized comparison bins ct″ₖ. The first party S may send to the second party R the plurality of randomized comparison bins ct″ₖ.

In one embodiment for optimizing the re-randomization runtime, the first party S may re-randomizing each of the plurality of comparison bins ct′ₖ simultaneously, using SIMD FHE, by: dividing the comparison bin ct′ₖ into a first and second segments of slots; cyclically rotating the first segment of slots by shifting slot indexes in a forward direction within the bin by a first set of rotation keys and the second segment of slots by shifting slot indexes in a reverse direction within the bin by a second set of rotation keys; randomizing the cyclically rotated slots; and aggregating the randomized cyclically rotated slots. In this runtime optimization, re-randomization uses a number of cyclic rotations and a number of rotation keys that is linear with the number of slots in each of the plurality of comparison bins ct′ₖ, for example, 2(l−1) equal to the number of slots l in each bin minus one for each rotation direction.

In one embodiment for reducing the re-randomization memory usage or inter-party communication, the first party S may re-randomizing each of the plurality of comparison bins ct′ₖ simultaneously, using SIMD FHE, by: dividing the comparison bin ct′ₖ into a plurality of individual slots; cyclically rotating each individual slot by shifting a slot one index at a time for a plurality of times within the bin by a first single-slot rotation key in one direction and by a second single-slot rotation key in an opposite direction; randomizing the cyclically rotated slots; and aggregating the randomized cyclically rotated slots. In this memory/communication optimization, re-randomization cyclically rotates all of the plurality of comparison bins ct′ₖ with the same two rotation keys using a number of rotations that is quadratic with the number of slots l² in each of the plurality of comparison bins ct′ₖ.

In operation 250, one or more processor(s) at the second party R, using a secret SIMD FHE key paired with the public SIMD FHE key, may simultaneously decrypt the plurality of randomized comparison bins ct″ₖ to reveal a plurality of unencrypted randomized comparison bins. Each of the plurality of unencrypted randomized comparison bins may either indicate a full match (e.g., containing all slots with a match value, e.g. zero) or a mismatch (e.g., containing all slots with a mismatch match value, e.g. randomized non-zero values) of the bin-to-bin comparison of the relatively large dataset X and the relatively small dataset Y. None of the plurality of unencrypted randomized comparison bins however can contain a combination of slots indicating a partial match (e.g., containing a combination of slots with a match (zero) and mismatch (non-zero) values) of the bin-to-bin comparison.

Additional or different steps, orders of steps or computations may be used than shown in FIG. 2.

As used herein, an intersection may refer to a positive match, comparison, query, or search of a smaller dataset entry within or to a larger dataset entry (a negative or no intersection may refer to its absence). A partial intersection may refer to a positive match, comparison, query, or search of a part (but not the whole) of the smaller dataset entry (e.g., a subset of slots matching a subset of digits) within or to a larger dataset entry (e.g., all slots of a complete bin representing a whole data entry).

Distinct parties S and R may be distinct entities, users, accounts and/or devices, where one party has limited trust or access to the data of the other party and/or cannot verify the authenticity of the other party.

As used herein, a small data entry may refer to an entry with a size less than or equal to 32 bits or 64 bits, or other similar sizes or comparable sizes in different units (e.g., 4 or 8 bytes). As used herein, a large data entry may refer to an entry with a size greater than a small entry, e.g., greater than 32 bits or 64 bits, and typically up to one or more orders of magnitude greater, such as, 4096 bits. As used herein, a relatively small dataset Y may have a number of data entries that is two or more orders of magnitude less than the number of data entries in a relatively large dataset X. Relatively large dataset X typically has a number of data entries greater than an order of 10³, e.g., 10⁶ or 10⁹, whereas relatively small dataset Y may have a number of data entries one or less than 10 or 100. Whereas embodiments of the invention support large data entries, some embodiments may still use small data entries or a combination of large and small data entries, e.g., depending on the data type, amount its division.

Although embodiments of the invention describe PSI that is asymmetric (where the size of Y is significantly smaller than the size of X, e.g., by one or more order(s) of magnitude), they may also apply to PSI that is symmetric (where X and Y are the same or similar sizes, e.g., the same order of magnitude).

In the foregoing description, various aspects of the present invention are described. For purposes of explanation, specific configurations and details are set forth in order to provide a thorough understanding of the present invention. However, it will also be apparent to one of ordinary skill in the art that the present invention may be practiced without the specific details presented herein. Furthermore, well known features may be omitted or simplified in order not to obscure the present invention.

Unless specifically stated otherwise, as apparent from the foregoing discussion, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

It should be recognized that embodiments of the present invention may solve one or more of the objectives and/or challenges described in the background, and that embodiments of the invention need not meet every one of the above objectives and/or challenges to come within the scope of the present invention. While certain features of the invention have been particularly illustrated and described herein, many modifications, substitutions, changes, and equivalents may occur to those of ordinary skill in the art. It is, therefore, to be understood that the appended claims are intended to cover all such modifications and changes in form and details as fall within the true spirit of the invention.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method for Asymmetric Private-Set Intersection (APSI), the method comprising:
at a first party S, storing a relatively large dataset X sorted into a plurality of bins, each bin comprising a plurality of slots;
at a second party R, using a SIMD FHE key, generating and sending to the first party S, a SIMD FHE ciphertext encrypting a relatively small dataset Y sorted into a plurality of bins ctₖ, each bin comprising a plurality of slots;
at the first party S, using SIMD FHE, executing a simultaneous bin-by-bin comparison of the bins of X with the bins of ciphertexts ctₖ of Y to generate a plurality of comparison bins ct′ₖ;
at the first party S, using SIMD FHE, re-randomizing by simultaneously executing cyclical rotations on a plurality of slots in each of the plurality of comparison bins ct′ₖ to generate a plurality of randomized comparison bins ct″ₖ;
at the first party S, sending to the second party R, the plurality of randomized comparison bins ct″ₖ; and
at the second party R, using a secret SIMD FHE key paired with the public SIMD FHE key, simultaneously decrypting the plurality of randomized comparison bins ct″ₖ to reveal a plurality of unencrypted randomized comparison bins each either indicating a full match or a mismatch of the bin-to-bin comparison of the relatively large dataset X and the relatively small dataset Y, wherein none of the plurality of unencrypted randomized comparison bins contain a combination of slots indicating a partial match of the bin-to-bin comparison.

2. The method of claim 1, wherein re-randomizing each of the plurality of comparison bins ct′ₖ simultaneously comprises, using SIMD FHE:
dividing the comparison bin ct′ₖ into a first and second segments of slots;
cyclically rotating the first segment of slots by shifting slot indexes in a forward direction within the bin by a first set of rotation keys and the second segment of slots by shifting slot indexes in a reverse direction within the bin by a second set of rotation keys;
randomizing the cyclically rotated slots; and
aggregating the randomized cyclically rotated slots.

3. The method of claim 2 comprising using a number of cyclic rotations and a number of rotation keys that is linear with the number of slots in each of the plurality of comparison bins ct′ₖ.

4. The method of claim 3, wherein the number of cyclic rotations and the number of rotation keys is 2(l−1) equal to the number of slots l in each bin minus one for each direction.

5. The method of claim 1, wherein re-randomizing each of the plurality of comparison bins ct′ₖ simultaneously comprises, using SIMD FHE:
dividing the comparison bin ct′ₖ into a plurality of individual slots;
cyclically rotating each individual slot by shifting a slot one index at a time for a plurality of times within the bin by a first single-slot rotation key in one direction and by a second single-slot rotation key in an opposite direction;
randomizing the cyclically rotated slots; and
aggregating the randomized cyclically rotated slots.

6. The method of claim 6 comprising cyclically rotating all of the plurality of comparison bins ct′ₖ with the same two rotation keys using a number of rotations that is quadratic with the number of slots l² in each of the plurality of comparison bins ct′k.

7. The method of claim 1 comprising:
at the first party S, hashing the relatively large dataset X; and
at the second party R, hashing the relatively small dataset Y.

8. A multi-party system for Asymmetric Private-Set Intersection (APSI), the system comprising:
one or more processors at a first party S; and
one or more processors a second party R, wherein:
the one or more processors at the first party S are configured to store a relatively large dataset X sorted into a plurality of bins, each bin comprising a plurality of slots, the one or more processors at a second party R are configured to, using a SIMD FHE key, generate and send to the first party S, a SIMD FHE ciphertext encrypting a relatively small dataset Y sorted into a plurality of bins ctk, each bin comprising a plurality of slots,
the one or more processors at the first party S are configured to:
using SIMD FHE, execute a simultaneous bin-by-bin comparison of the bins of X with the bins of ciphertexts ctₖ of Y to generate a plurality of comparison bins ct′ₖ,
using SIMD FHE, re-randomize by simultaneously executing cyclical rotations on a plurality of slots in each of the plurality of comparison bins ct′ₖ to generate a plurality of randomized comparison bins ct″ₖ, and
send to the second party R, the plurality of randomized comparison bins ct″ₖ, and
the one or more processors at the second party R are configured to, using a secret SIMD FHE key paired with the public SIMD FHE key, simultaneously decrypt the plurality of randomized comparison bins ct″ₖ to reveal a plurality of unencrypted randomized comparison bins each either indicating a full match or a mismatch of the bin-to-bin comparison of the relatively large dataset X and the relatively small dataset Y, wherein none of the plurality of unencrypted randomized comparison bins contain a combination of slots indicating a partial match of the bin-to-bin comparison.

9. The system of claim 8, wherein the one or more processors at the first party S are configured to re-randomize each of the plurality of comparison bins ct′ₖ simultaneously, using SIMD FHE, by:
dividing the comparison bin ct′ₖ into a first and second segments of slots,
cyclically rotating the first segment of slots by shifting slot indexes in a forward direction within the bin by a first set of rotation keys and the second segment of slots by shifting slot indexes in a reverse direction within the bin by a second set of rotation keys,
randomizing the cyclically rotated slots, and
aggregating the randomized cyclically rotated slots.

10. The system of claim 9, wherein the one or more processors at the first party S are configured to cyclically rotate using a number of cyclic rotations and a number of rotation keys that is linear with the number of slots in each of the plurality of comparison bins ct′ₖ.

11. The system of claim 10, wherein the number of cyclic rotations and the number of rotation keys is 2(l−1) equal to the number of slots l in each bin minus one for each direction.

12. The system of claim 8, wherein the one or more processors at the first party S are configured to re-randomize each of the plurality of comparison bins ct′ₖ simultaneously, using SIMD FHE, by:
dividing the comparison bin ct′ₖ into a plurality of individual slots,
cyclically rotating each individual slot by shifting a slot one index at a time for a plurality of times within the bin by a first single-slot rotation key in one direction and by a second single-slot rotation key in an opposite direction,
randomizing the cyclically rotated slots, and
aggregating the randomized cyclically rotated slots.

13. The method of claim 12 wherein the one or more processors at the first party S are configured to cyclically rotate all of the plurality of comparison bins ct′ₖ with the same two rotation keys using a number of rotations that is quadratic with the number of slots l² in each of the plurality of comparison bins ct′ₖ.

14. The system of claim 8 wherein:
the one or more processors at the first party S are configured to hash the relatively large dataset X, and
the one or more processors at the second party R are configured to hash the relatively small dataset Y.

15. Non-transitory computer-readable storage media storing instructions at computing systems operated by a first party S and a second party R that, when executed by the computing systems, cause the computing systems to perform operations for Asymmetric Private-Set Intersection (APSI), the operations comprising:
at the first party S, storing a relatively large dataset X sorted into a plurality of bins, each bin comprising a plurality of slots;
at the second party R, using a SIMD FHE key, generating and sending to the first party S, a SIMD FHE ciphertext encrypting a relatively small dataset Y sorted into a plurality of bins ctₖ, each bin comprising a plurality of slots;
at the first party S, using SIMD FHE, executing a simultaneous bin-by-bin comparison of the bins of X with the bins of ciphertexts ctk of Y to generate a plurality of comparison bins ct′ₖ;
at the first party S, using SIMD FHE, re-randomizing by simultaneously executing cyclical rotations on a plurality of slots in each of the plurality of comparison bins ct′ₖ to generate a plurality of randomized comparison bins ct″ₖ;
at the first party S, sending to the second party R, the plurality of randomized comparison bins ct″ₖ; and
at the second party R, using a secret SIMD FHE key paired with the public SIMD FHE key, simultaneously decrypting the plurality of randomized comparison bins ct″ₖ to reveal a plurality of unencrypted randomized comparison bins each either indicating a full match or a mismatch of the bin-to-bin comparison of the relatively large dataset X and the relatively small dataset Y, wherein none of the plurality of unencrypted randomized comparison bins contain a combination of slots indicating a partial match of the bin-to-bin comparison.

16. The non-transitory computer-readable storage medium of claim 15 storing instructions at the computing system operated by the first party S that, when executed by the computing system, cause the computing system to re-randomize each of the plurality of comparison bins ct′ₖ simultaneously, using SIMD FHE, by:
dividing the comparison bin ct′ₖ into a first and second segments of slots;
cyclically rotating the first segment of slots by shifting slot indexes in a forward direction within the bin by a first set of rotation keys and the second segment of slots by shifting slot indexes in a reverse direction within the bin by a second set of rotation keys;
randomizing the cyclically rotated slots; and
aggregating the randomized cyclically rotated slots.

17. The non-transitory computer-readable storage medium of claim 16 storing instructions at the computing system operated by the first party S that, when executed by the computing system, cause the computing system to cyclically rotate using a number of cyclic rotations and a number of rotation keys that is linear with the number of slots in each of the plurality of comparison bins ct′ₖ.

18. The non-transitory computer-readable storage medium of claim 17, wherein the number of cyclic rotations and the number of rotation keys is 2(l−1) equal to the number of slots l in each bin minus one for each direction.

19. The non-transitory computer-readable storage medium of claim 15 storing instructions at the computing system operated by the first party S that, when executed by the computing system, cause the computing system to re-randomize each of the plurality of comparison bins ct′ₖ simultaneously, using SIMD FHE, by:
dividing the comparison bin ct′ₖ into a plurality of individual slots;
cyclically rotating each individual slot by shifting a slot one index at a time for a plurality of times within the bin by a first single-slot rotation key in one direction and by a second single-slot rotation key in an opposite direction;
randomizing the cyclically rotated slots; and
aggregating the randomized cyclically rotated slots.

20. The non-transitory computer-readable storage medium of claim 19 storing instructions at the computing system operated by the first party S that, when executed by the computing system, cause the computing system to cyclically rotate all of the plurality of comparison bins ct′ₖ with the same two rotation keys using a number of rotations that is quadratic with the number of slots l² in each of the plurality of comparison bins ct′ₖ.
